(19) United States
(12) Patent Application Publication
(10) Pub. No.: US 2018/0157871 A1
(43) Pub. Date: Jun. 7, 2018

(54) CAPACITIVE INTRUSION DETECTION ON SMARTCARD READER

(71) Applicant: NXP B.V.

(72) Inventors: Leonhard Kormann, Stallhofen (AT); Christian Eisendle, Graz (AT)

(21) Appl. No.: 15/367,029

(22) Filed: Dec. 1, 2016

(51) Int. Cl. G06K 7/00; G06K 19/073

(52) U.S. Cl. CPC G06K 7/0091; G06K 19/073; G06K 7/0095

(57) ABSTRACT

A device is disclosed. The device comprises a secure microcontroller, a smart card reader module coupled to the secure microcontroller, a smart card connector coupled to the smart card reader module through a coupling line and a capacitive sensor coupled to the coupling line and the secure microcontroller. The secure microcontroller is configured to receive a value of parasitic capacitance through the capacitive sensor and disable the device if the value is above a prestored value in the secure microcontroller.

### BACKGROUND

Smart cards are increasing being used for improving transactional security. A smart card typically includes an electronic system that can store and transmit identity or transactional data. A smart card may communicate via physical contact pad or wirelessly through near field communication. In cases where the smart card is designed to communicate with a smart card reader using physical contacts, a connector on the smart card touches a counterpart connector on the smart card reader. It is possible to connect a third device to the contact pad or on the line behind the contact pad of the smart card reader to read the information being transmitted from the smart card to the smart card reader.

Typically temper meshes are used over contact pads to identify installation of the third device. Temper meshes are securely connected to the processing system of the card reader and when temper meshes are removed or tempered with, the processing system makes the card reader inoperable to protect against data theft.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

In one embodiment, a device is disclosed. The device comprises a secure microcontroller, a smart card reader module coupled to the secure microcontroller, a smart card connector coupled to the smart card reader module through a coupling line and a capacitive sensor coupled to the coupling line and the secure microcontroller. The secure microcontroller is configured to receive a value of parasitic capacitance through the capacitive sensor and disable the device if the value is above a prestored value in the secure microcontroller.

In another embodiment, a method of detecting an intrusion in a smart card reader is disclosed. The method includes detecting that no communication is ongoing between a smart card and the smart card reader and upon detecting that no communication is ongoing, applying a voltage a communication line between a smart card connector and a smart card reader module. The method further includes measuring parasitic capacitance on the communication line at a predetermined time interval after applying the voltage and disabling the smart card reader if the measured parasitic capacitance is higher than a predetermined value.

In yet another embodiment, a computer readable media comprising programming instructions is disclosed. When programming instructions are executed by a processor performs an operation. The operation includes detecting that no communication is ongoing between a smart card and the smart card reader and upon detecting that no communication is ongoing, applying a voltage a communication line between a smart card connector and a smart card reader module. The operation further includes measuring parasitic capacitance on the communication line at a predetermined time interval after applying the voltage and disabling the smart card reader if the measured parasitic capacitance is higher than a predetermined value.

In some embodiments, the coupling line includes an input/output line and a clock line and the value of the parasitic capacitance is measured at a predetermined time after applying a voltage to the coupling line. The prestored value is determined during a manufacturing and testing process of the device and stored in a memory of the secure microcontroller. A value of the predetermined time is determined during a manufacturing and testing of the device and stored in the secure microcontroller

In some embodiments, the disabling of the smart card reader includes disabling a smart card reader module from initiating a communication on the coupling line.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments. Advantages of the subject matter claimed will become apparent to those skilled in the art upon reading this description in conjunction with the accompanying drawings, in which like reference numerals have been used to designate like elements, and in which:

FIG. 1 depicts a schematic of a smart card reader in accordance with one or more embodiments of the present disclosure;

FIG. 2 shows graphs to illustrate identifying intrusions in accordance with one or more embodiments of the present disclosure; and

FIG. 3 illustrates a method of identifying intrusions in accordance with one or more embodiments of the present disclosure.

Note that figures are not drawn to scale. Intermediate steps between figure transitions have been omitted so as not to obfuscate the disclosure. Those intermediate steps are known to a person skilled in the art.

### DETAILED DESCRIPTION

Many well-known manufacturing steps, components, and connectors have been omitted or not described in details in the description so as not to obfuscate the present disclosure. The embodiments described herein can be used for making the use of the security mesh over the contact reader slot and also to detect instruction by a third device to prevent data theft.

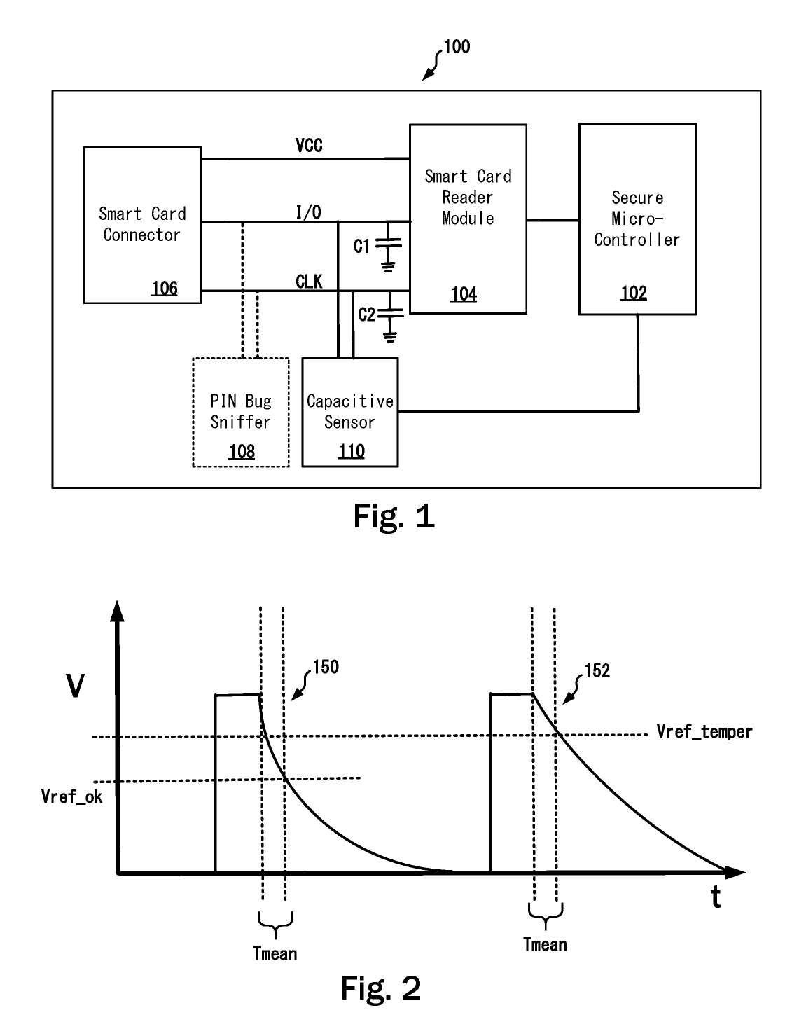

FIG. 1 depicts a schematic of a smart card reader 100. The smart card reader 100 includes a smart card connector 106 which may be housed in a slot where a smart card can be inserted and the counterpart connector in the smart card comes a physical touch with the smart card connector 106. The smart card reader 100 also includes a smart card reader module 104 that is configured to receive data from the smart card via the smart card connector 106 and provide the received data to a secure micro-controller 102 for further processing which may include sending the data securely to an offsite computer system, such as a bank's computer system. In some embodiments, the smart card reader module 104 may be configured to perform an initial data integrity check to ascertain that the smart card is in proper touch with the smart card connector 106.

The smart card connector 106 is coupled to the smart card reader module 104 via VCC (supply), CLK (clock) and I/O (input/output) lines. A PIN bug sniffer 108 is shown only to illustrate the hacking of the I/O line. The smart card reader 100 may be opened and the PIN bug sniffer 108 may be installed to capture the data being transmitted over the I/O line. The PIN bug sniffer 108 may then transmit the data to an external device typically wirelessly thus compromising the integrity of the data communication over the I/O line. The embodiments described herein are directed to prevent such intrusions by these third party rouge devices.

Two capacitors C1 and C2 may be capacitive components or they may also represent parasitic capacitance of the coupled components around these capacitors. For the ease of description, C1 and C2 are being assumed to be parasitic capacitances. A capacitive sensor 110 is included to measure a discharge rate of the capacitors C1 and C2. The capacitive sensor 110 is coupled to the secure micro-controller 102. The secure micro-controller 102 is configured to receive data from the capacitive sensor 110 and make a decision whether there is an intrusion in the I/O line according to present configurations and settings. The settings may include reference discharge rates of the capacitance in the I/O and/or CLK line. In some embodiments, the secure microcontroller 102 may also send data to the capacitive sensor 110, for example to instruct the capacitive sensor 110 to apply a voltage to the I/O line to start parasitic capacitance measurements, as described below.

In some embodiments, the capacitive sensor 110 includes capacitance sensing material such as Indium Tin Oxide (ITO), Flame Retardant (FR), Flex, or any similar material that exhibits capacitance sensing capabilities. The capacitive sensor 110 also includes a voltage measuring circuit what provides data to the secure micro-controller 102 to determine voltage values.

FIG. 2 shows graphs to illustrate identifying intrusions. FIG. 2 includes two graphs 150 and 152 to provide an ease of understanding as to how a determination is made whether an intrusion is present or not present. The programming logic and configurations are stored in the secure microcontroller 102 (or in a memory built into, or located outside of the secure microcontroller 102).

When no communication is ongoing on the I/O line, a voltage is applied for a predetermined period of time, to the I/O line to charge the parasitic capacitance. The voltage may be applied by the smart card reader module 104 or by the capacitive sensor 110 upon being instructed by the secure microcontroller 102. As soon as the applied voltage is removed from being further applied to the I/O line, the parasitic capacitance starts to discharge. Starting at the moment when the voltage is removed to a predetermined time period, the parasitic capacitance will discharge to a particular value or less, as predetermined and stored in the secure microcontroller 102. As shown in the graph 150, the value drops to V_{ref}_{_}ₒₖ after Tₘₑₐₙ time period from the removing the voltage. V_{ref}_{_}ₒₖ is equal or lower than a predetermined value stored in the secure microcontroller 102. When a rogue third party device (e.g., the PIN bug sniffer 108) is inserted as shown in FIG. 1, a person skilled in the art would know that the parasitic capacitance increases. Due to this increased parasitic capacitance, in Tₘₑₐₙ time interval, the value does not fall as much as when the parasitic capacitance was less. This value is shown as V_{ref}_{_}ₜₑₘₚₑᵣ which indicates that the I/O line has been tempered with.

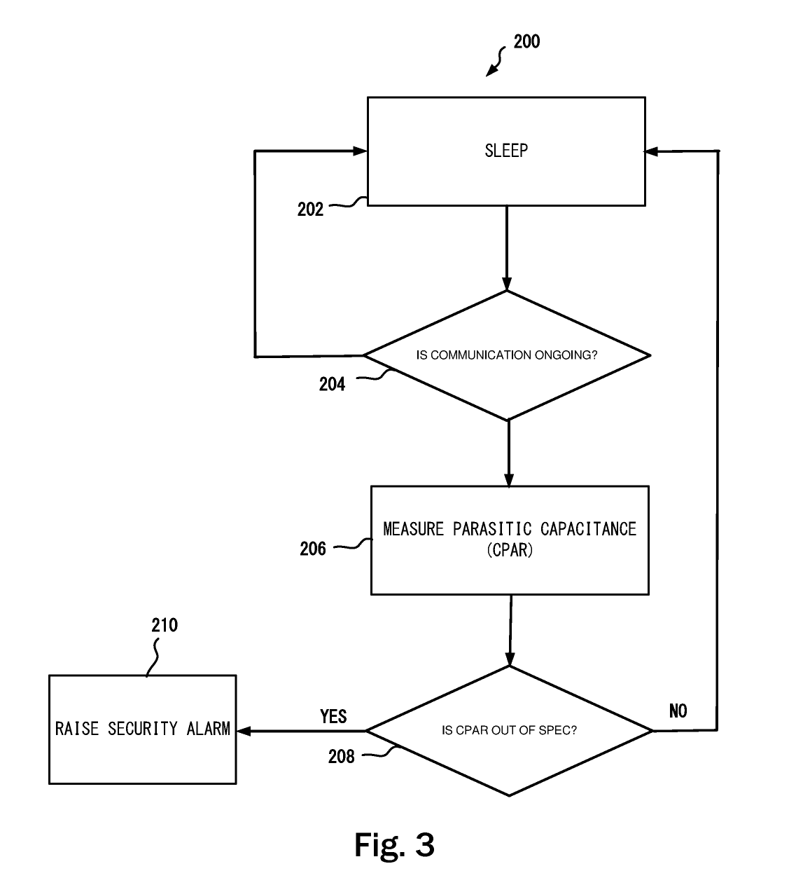

FIG. 3 illustrates a method 200 of identifying intrusions. Accordingly, at steps 202 and 204, the secure microcontroller 102 detects that no communication is ongoing on the I/O line. If a communication is detected, no action is taken for a predetermined time interval. At step 204, if no communication is ongoing on the I/O line, the capacitance is measured through the capacitive sensor 110 by applying a voltage to the I/O line, as described above. If the measured capacitance or voltage is below a preselected value, the control goes back to step 202. If the measured capacitance or voltage is above the predetermined value, the smart card reader 100 is disabled and/or a security alarm is raised.

Some or all of these embodiments may be combined, some may be omitted altogether, and additional process steps can be added while still achieving the products described herein. Thus, the subject matter described herein can be embodied in many different variations, and all such variations are contemplated to be within the scope of what is claimed.

While one or more implementations have been described by way of example and in terms of the specific embodiments, it is to be understood that one or more implementations are not limited to the disclosed embodiments. To the contrary, it is intended to cover various modifications and similar arrangements as would be apparent to those skilled in the art. Therefore, the scope of the appended claims should be accorded the broadest interpretation so as to encompass all such modifications and similar arrangements.

The use of the terms “a” and “an” and “the” and similar referents in the context of describing the subject matter (particularly in the context of the following claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. Furthermore, the foregoing description is for the purpose of illustration only, and not for the purpose of limitation, as the scope of protection sought is defined by the claims as set forth hereinafter together with any equivalents thereof entitled to. The use of any and all examples, or exemplary language (e.g., “such as”) provided herein, is intended merely to better illustrate the subject matter and does not pose a limitation on the scope of the subject matter unless otherwise claimed. The use of the term “based on” and other like phrases indicating a condition for bringing about a result, both in the claims and in the written description, is not intended to foreclose any other conditions that bring about that result. No language in the specification should be construed as indicating any non-claimed element as essential to the practice of the invention as claimed.

Preferred embodiments are described herein, including the best mode known to the inventor for carrying out the claimed subject matter. Of course, variations of those preferred embodiments will become apparent to those of ordinary skill in the art upon reading the foregoing description. The inventor expects skilled artisans to employ such variations as appropriate, and the inventor intends for the claimed subject matter to be practiced otherwise than as specifically described herein. Accordingly, this claimed subject matter includes all modifications and equivalents of the subject matter recited in the claims appended hereto as permitted by applicable law. Moreover, any combination of the above-described elements in all possible variations thereof is encompassed unless otherwise indicated herein or otherwise clearly contradicted by context.

What is claimed is:

1. A device, comprising:
a secure microcontroller;
a smart card reader module coupled to the secure microcontroller;
a smart card connector coupled to the smart card reader module through a coupling line; and
a capacitive sensor coupled to the coupling line and the secure microcontroller;
wherein the secure microcontroller is configured to receive a value of parasitic capacitance through the capacitive sensor and disable the device if the value is above a prestored value in the secure microcontroller.

2. The device of claim 1, wherein the coupling line includes an input/output line and a clock line.

3. The device of claim 1, wherein the value of the parasitic capacitance is measured at a predetermined time after applying a voltage to the coupling line.

4. The device of claim 1, wherein the prestored value is determined during a manufacturing and testing process of the device and stored in a memory of the secure microcontroller.

5. The device of claim 1, wherein the disabling of the device includes disabling the smart card reader module from initiating a communication on the coupling line.

6. The device of claim 3, wherein a value of the predetermined time is determined during a manufacturing and testing of the device and stored in the secure microcontroller.

7. A method of detecting an intrusion in a smart card reader, the method comprising:
detecting that no communication is ongoing between a smart card and the smart card reader;
upon detecting that no communication is ongoing, applying a voltage a communication line between a smart card connector and a smart card reader module;
measuring parasitic capacitance on the communication line at a predetermined time interval after applying the voltage; and
disabling the smart card reader if the measured parasitic capacitance is higher than a predetermined value.

8. The device of claim 7, wherein the value of the parasitic capacitance is measured at a predetermined time after applying a voltage to the coupling line.

9. The device of claim 7, wherein the predetermined value is determined during a manufacturing and testing process of the device and stored in a memory of the secure microcontroller.

10. The device of claim 7, wherein the disabling of the smart card reader includes disabling a smart card reader module from initiating a communication on the communication line.

11. A computer readable media comprising programming instructions which when executed by a processor performs an operation, the operation includes:
detecting that no communication is ongoing between a smart card and the smart card reader;
upon detecting that no communication is ongoing, applying a voltage a communication line between a smart card connector and a smart card reader module;
measuring parasitic capacitance on the communication line at a predetermined time interval after applying the voltage; and
disabling the smart card reader if the measured parasitic capacitance is higher than a predetermined value.

12. The device of claim 11, wherein the value of the parasitic capacitance is measured at a predetermined time after applying a voltage to the coupling line.

13. The device of claim 11, wherein the predetermined value is determined during a manufacturing and testing process of the device and stored in a memory of the secure microcontroller.

14. The device of claim 11, wherein the disabling of the smart card reader includes disabling a smart card reader module from initiating a communication on the communication line.
